(19) United States
(12) Patent Application Publication
(10) Pub. No.: US 2018/0147986 A1
(43) Pub. Date: May 31, 2018

(54) METHOD AND SYSTEM FOR VEHICLE-BASED IMAGE-CAPTURING

(71) Applicant: Faraday&Future Inc., Gardena, CA (US)

(72) Inventors: Hongyue Chi, San Jose, CA (US); Meishuangzi Liu, San Jose, CA (US); Guofeng Liu, Newark, CA (US); Anna Angelica Lyubich, Sunnyvale, CA (US)

(21) Appl. No.: 15/639,370

(22) Filed: Jun. 30, 2017

Related U.S. Application Data
(60) Provisional application No. 62/357,283, filed on Jun. 30, 2016.

(51) Int. Cl. B60R 1/00; G06T 7/70; H04N 5/247

(52) U.S. Cl. CPC B60R 1/00; G06T 7/70; H04N 5/247; G06T 2207/30252; B60R 2300/105; B60R 2300/302; B60R 2300/404; B60R 2300/301; B60R 2300/108

(57) ABSTRACT

A system for vehicle-based image-capturing is disclosed. The system may comprise an interface configured to receive an input, and a first sensor of a vehicle configured to capture an image based on the user input.

### CROSS-REFERENCE TO RELATED APPLICATIONS

This application claims the benefit of U.S. Provisional Application No. 62/357,283, filed Jun. 30, 2016, the entirety of which is hereby incorporated by reference.

### TECHNICAL FIELD

The present disclosure relates generally to methods and systems for specialized vehicle, and more particularly, to methods and systems for vehicle-based image-capturing.

### BACKGROUND

Vehicle occupants often take photos from the vehicles. For example, a family driving on California route 1 may want to capture the breathtaking view of the pacific coast. For another example, a fan may spot a movie star at a grand opening event, while driving down the 5^{th} Avenue of New York City, and cannot wait to take a photo of her idol.

With current technologies, people in these situation do not usually find good options to take clear pictures without causing safety issues. Often, road conditions, such as the cliff-facing route 1 and the over-crowded 5^{th} avenue, do not allow temporary parking and photo-taking. Further, if a passenger chooses to make a shot from the inside of the vehicle, it may take a while to get a camera ready, long after the most desirable scene lapses. Even if the passenger manages to have a camera ready in hand, the camera view may be blocked, blurred, or interfered by windshields, windows, or other occupants.

### SUMMARY

One aspect of the present disclosure is directed to a system for vehicle-based image-capturing. The system may comprise an interface configured to receive an input, and a first sensor of a vehicle configured to capture an image based on the input.

Another aspect of the present disclosure is directed to a vehicle. The vehicle may comprise a system for vehicle-based image-capturing. The system may comprise an interface configured to receive an input, and a first sensor configured to capture an image based on the input.

Another aspect of the present disclosure is directed to a method for vehicle-based image-capturing. The method may comprise receiving, by an interface, an input; and capturing, by a first sensor of a vehicle, an image based on the input.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a graphical representation illustrating a vehicle for vehicle-based image-capturing, consistent with exemplary embodiments of the present disclosure.

FIG. 2 is a graphical representation illustrating a vehicle for vehicle-based image-capturing, consistent with exemplary embodiments of the present disclosure.

FIG. 3 is a block diagram illustrating a system for vehicle-based image-capturing, consistent with exemplary embodiments of the present disclosure.

FIG. 4 is a flowchart illustrating a method for vehicle-based image-capturing, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Current vehicles do not provide convenient, safe, reliable, and high-quality image-capturing functions. The disclosed systems and methods may mitigate or overcome one or more of the problems set forth above and/or other problems in the prior art.

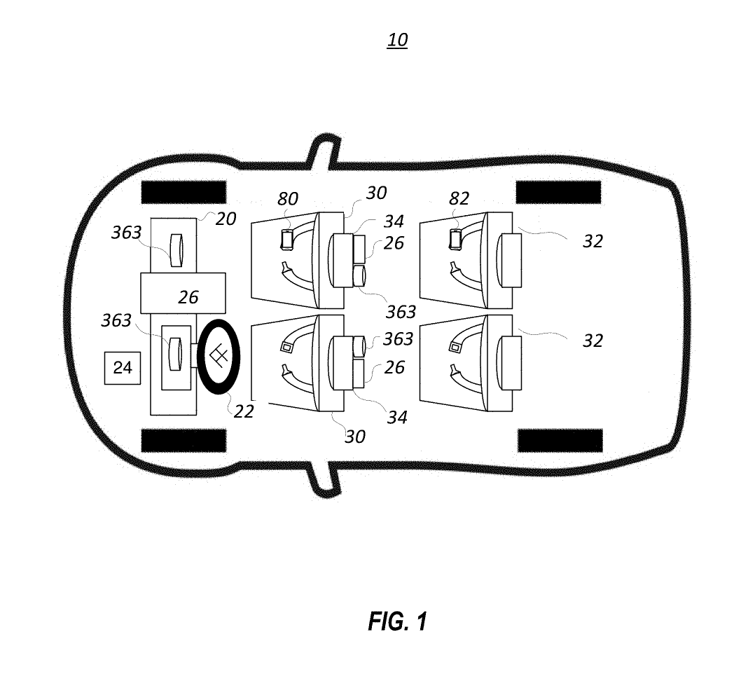

FIG. 1 is a graphical representation illustrating a vehicle 10 for vehicle-based image-capturing from a top-view, consistent with exemplary embodiments of the present disclosure. Vehicle 10 may have any body style of an automobile, such as a sports car, a coupe, a sedan, a pick-up truck, a station wagon, a sports utility vehicle (SUV), a minivan, or a conversion van. Vehicle 10 may also embody other types of transportation, such as motorcycles, boats, buses, trains, and planes. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomous.

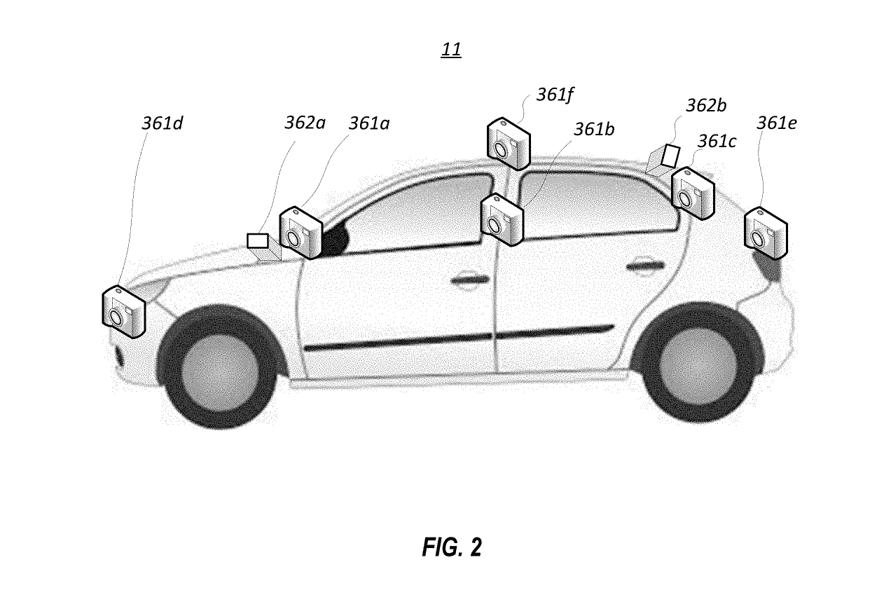

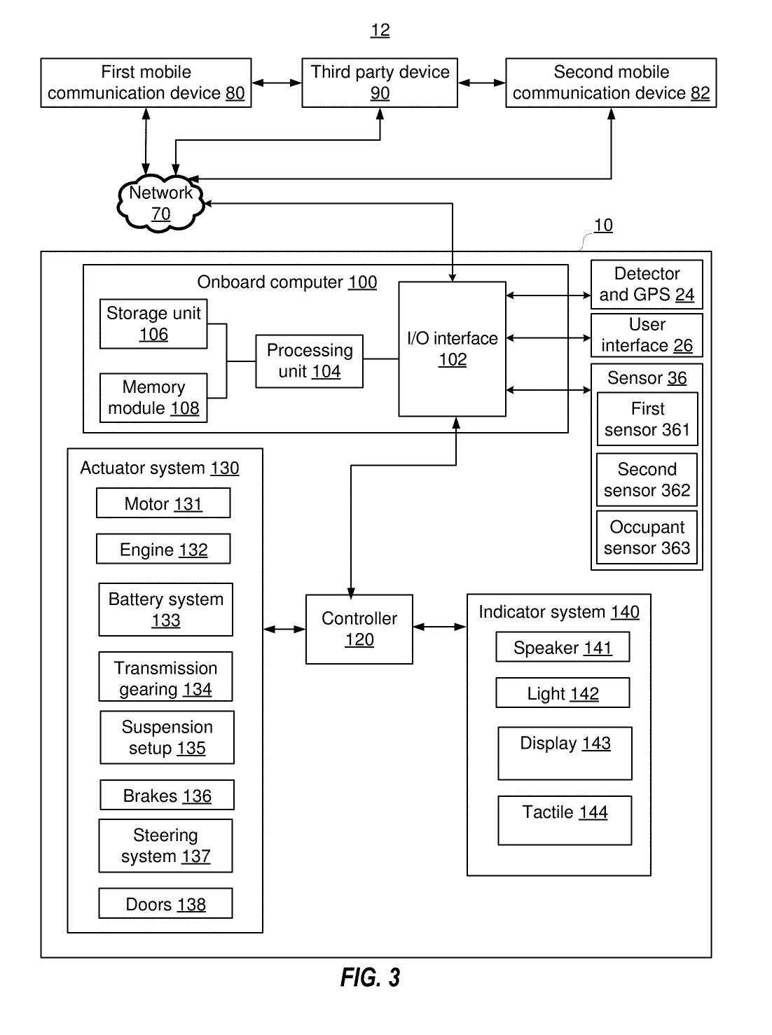

As illustrated in FIG. 1, vehicle 10 may include a number of components, some of which may be optional. Vehicle 10 may have a dashboard 20 through which a steering wheel 22 and a user interface 26 may project. In one example of an autonomous vehicle, vehicle 10 may not include steering wheel 22. Vehicle 10 may also have one or more front seats 30 and one or more back seats 32 configured to accommodate occupants. Vehicle 10 may further include one or more sensors 36 (shown in FIG. 3). One or more sensors 36 may comprise one or more first sensors 361, one or more second sensors 362, and/or one or more occupant sensors 363 (first sensors 361 and second sensors 362 will be described in more details below with reference to FIG. 2 and FIG. 3, only sensors 363 are shown in FIG. 1). Vehicle 10 may also include a detector and GPS unit 24 disposed in front of steering wheel 22 or on the top of the vehicle to detect objects, receive signals (e.g., GPS signal), and/or transmit data. The detector may include an onboard camera. Detector and GPS 24 may determine in real time the location of vehicle 10 and/or information of the surrounding environment, such as street signs, lane patterns, road marks, road conditions, environment conditions, weather conditions, and traffic conditions. The positions of the various components of vehicle 10 in FIG. 1 are merely illustrative and are not limited as shown in the figure. For example, sensors 363 may include an infrared sensor disposed on a door next to an occupant, or a weight sensor embedded in a seat. Detector and sensor unit 24 may be disposed at another position in the vehicle.

In some embodiments, user interface 26 may be configured to receive inputs from users or devices and transmit data. For example, user interface 26 may have a display including an LCD, an LED, a plasma display, or any other type of display, and provide a graphical user interface (GUI) presented on the display for user input and data display. User interface 26 may further include speakers or other voice playing devices. User interface 26 may further include input devices, such as a touchscreen, a keyboard, a mouse, a microphone, and/or a tracker ball, to receive a user input. User interface 26 may also connect to a network to remotely receive instructions or user inputs. Thus, the input may be directly entered by a current occupant, captured by interface 26, or received by interface 26 over the network. User interface 26 may further include a housing having grooves containing the input devices. User interface 26 may be configured to provide internet access, cell phone access, and/or in-vehicle network access, such as Bluetooth™, CAN bus, or any other vehicle bus architecture protocol that may be used to access features or settings within vehicle 10. User interface 26 may be further configured to display or broadcast other media, such as images, videos, and maps.

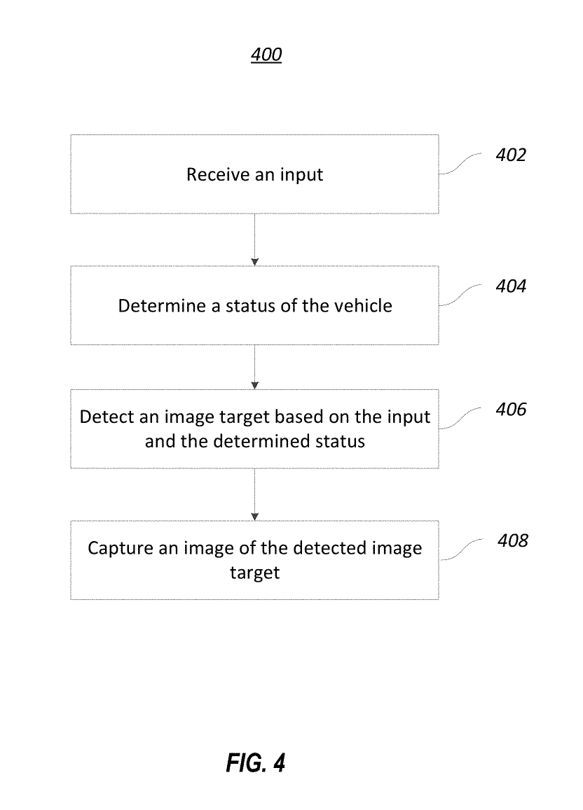

User interface 26 may also be configured to receive user-defined settings. For example, user interface 26 may receive settings of first sensors 361 described below with reference to FIG. 4. For another example, user interface 26 may be configured to receive occupant profiles including, for example, an age, a gender, a driving license status, an advanced driver assistance systems (ADAS) license status, an individual driving habit, a frequent destination, an associated photo album, an associated video, and etc. In some embodiments, user interface 26 may include a touch-sensitive surface configured to receive biometric data (e.g., detect a fingerprint of an occupant). The touch-sensitive surface may be configured to detect the ridges and furrows of a fingerprint based on a change in capacitance and generate a signal based on the detected fingerprint, which may be processed by an onboard computer described below with reference to FIG. 3. The onboard computer may be configured to compare the signal with stored data to determine whether the fingerprint matches recognized occupants. The onboard computer may also be able to connect to the Internet, obtain data from the Internet, and compare the signal with obtained data to identify the occupants. User interface 26 may be configured to include biometric data into a signal, such that the onboard computer may be configured to identify the person generating an input. User interface 26 may also compare a received voice input with stored voices to identify the person generating the input. Furthermore, user interface 26 may be configured to store data history accessed by the identified person.

Sensor 363 may include any device configured to generate a signal to be processed to detect and/or recognize occupants of vehicle 10, for example, camera, microphone sound detection sensor, infrared sensor, weight sensor, radar, ultrasonic, LIDAR sensor, or wireless sensor for obtaining identification from occupants' cell phones. In one example, a camera 363 may be positioned on the back of a headrest 34 of a front seat 30 to capture images of an occupant in a back seat 32. In some embodiments, visually captured videos or images of the interior of vehicle 10 by camera 363 may be used in conjunction with an image recognition software, such that the software may distinguish a person from inanimate objects, and may recognize the person based on physical appearances or traits. The image recognition software may include a facial recognition software configured to match a captured occupant with stored profiles to identify the occupant. In some embodiments, more than one sensor may be used in conjunction to detect and/or recognize the occupant(s). For example, sensor 363 may include a camera and a microphone, and captured images and voices may both work as filters to identify the occupant(s) based on stored profiles.

In some embodiments, sensor 363 may include one or more electrophysiological sensors for encephalography-based autonomous driving. For example, a fixed sensor 363 may detect electrical activities of brains of the occupant(s) and convert the electrical activities to signals, such that the onboard computer can control the vehicle based on the signals. Sensor 363 may also be detachable and head-mountable, and may detect the electrical activities when worn by the occupant(s).

Vehicle 10 may be in communication with a plurality of mobile communication devices 80, 82. Mobile communication devices 80, 82 may include a number of different structures. For example, mobile communication devices 80, 82 may include a smart phone, a tablet, a personal computer, a wearable device, such as a smart watch or Google Glass™, and/or complimentary components. Mobile communication devices 80, 82 may be configured to connect to a network, such as a nationwide cellular network, a local wireless network (e.g., Bluetooth™ or WiFi), and/or a wired network. Mobile communication devices 80, 82 may also be configured to access apps and websites of third parties, such as iTunes™, Pandora™, Google™, Facebook™, and Yelp™.

In some embodiments, mobile communication devices 80, 82 may be carried by or associated with one or more occupants in vehicle 10. For example, vehicle 10 may be configured to determine the presence of specific people based on a digital signature or other identification information from mobile communication devices 80, 82. For instance, an onboard computer may be configured to relate the digital signature to stored profile data including the person's name and the person's relationship with vehicle 10. The digital signature of mobile communication devices 80, 82 may include a determinative emitted radio frequency (RF) or a global positioning system (GPS) tag. Mobile communication devices 80, 82 may be configured to automatically connect to or be detected by vehicle 10 through local network 70, e.g., Bluetooth™ or WiFi, when positioned within a proximity (e.g., within vehicle 10).

FIG. 2 is a graphical representation illustrating a vehicle 11 for vehicle-based image-capturing from a side-view, consistent with exemplary embodiments of the present disclosure. Vehicle 11 may be an alternative representation of vehicle 10 described above.

As illustrated in FIG. 2, vehicle 11 may include one or more first sensors 361 and one or more second sensors 362 disposed at various locations on vehicle 11. For example, sensor 361a may be disposed on the A-pillar of vehicle 11, sensor 361b may be disposed on the B-pillar of vehicle 11, sensor 361c may be disposed on the C-pillar of vehicle 11, sensor 361d may be disposed on a front bumper of vehicle 11, sensor 361e may be disposed on a rear trunk of vehicle 11, and sensor 361f may be disposed on a top ceiling of vehicle 11. Sensor 362a may be disposed next to sensor 361a, and sensor 362b may be disposed next to sensor 361c. Some of the sensors 361 (361a-361f collectively referred to as 361) and 362 (362a and 362b collectively referred to as 362) may be optional. Depending on the vehicle type and configuration, sensors 361 and 362 can also be disposed on other parts of the vehicle, such as the doors and the D-pillar. Sensors 361 and 362 may also be paired and disposed at the same locations. Sensors 361 and 362 may be disposed on various parts of the vehicle via various configurations, such as attaching onto the vehicle parts, integrating into the vehicle parts, attaching inside the vehicle parts, or attaching behind the vehicle parts. The sensors can detect the outside and/or the inside environment of the vehicle.

Examples of sensors 361 and 362 may include cameras (e.g., digital cameras), infra-red cameras, high-speed cameras, camcorders, video cameras, digital media players (PMPs), panorama cameras, camera phones, light detection and ranging (LIDAR) sensor, smart phones, personal digital assistants (PDAs), tablet computing devices, laptop computers, desktop computers, smart TVs, game consoles, and the like. In some embodiments, first sensors 361 are cameras and second sensors 362 are LIDAR sensors. Sensors 361 and 362 may include various lens configurations, such as zoom in/zoom out lenses, wide angle lenses, filtering lenses, and the like. Sensors 361 and 362 may be connected to onboard computer 100 by wire or wirelessly, and configured and controlled by onboard computer 100 described below with reference to FIG. 3. Sensors 361 and 362 may also be configured to be connected and controlled by mobile communication devices 80, 82, through wireless communications. Sensors 361 and 362 may be battery-powered, wirelessly chargeable, and/or powered by solar panels attached to the vehicle 11.

FIG. 3 is a block diagram illustrating a system 12 for vehicle-based image-capturing, consistent with exemplary embodiments of the present disclosure. System 12 may include a number of components, some of which may be optional. As illustrated in FIG. 3, system 12 may include vehicle 10, as well as other external devices connected to vehicle 10 through network 70. The external devices may include mobile terminal devices 80, 82, and third party device 90. Vehicle 10 may include a specialized onboard computer 100, a controller 120, an actuator system 130, an indicator system 140, a detector and GPS unit 24, a user interface 26, and a sensor 36. Onboard computer 100, actuator system 130, and indicator system 140 may all connect to controller 120. Sensor 36, user interface 26, and detector and GPS unit 24 may all connect to onboard computer 100. Onboard computer 100 may comprise, among other things, an I/O interface 102, a processing unit 104, a storage unit 106, a memory module 108. The above units of system 12 may be configured to transfer data and send or receive instructions between or among each other. Storage unit 106 and memory module 108 may be non-transitory and computer-readable and store instructions that, when executed by processing unit 104, cause vehicle 10 to perform the methods described in this disclosure. Onboard computer 100 may be specialized to perform the methods and steps described below.

I/O interface 102 may also be configured for two-way communication between onboard computer 100 and various components of system 12, such as user interface 26, detector and GPS 24, sensor 36, and the external devices. I/O interface 102 may send and receive operating signals to and from mobile communication devices 80, 82 and third party devices 90. I/O interface 102 may send and receive the data between each of the devices via communication cables, wireless networks, or other communication mediums. For example, mobile communication devices 80, 82 and third party devices 90 may be configured to send and receive signals to I/O interface 102 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Third party devices 90 may include smart phones, personal computers, laptops, pads, servers, and/or processors of third parties that provide access to contents and/or data (e.g., maps, traffic, store locations, and weather). Third party devices 90 may be accessible to the users through mobile communication devices 80, 82 or directly accessible by onboard computer 100, via I/O interface 102, according to respective authorizations of the user. For example, users may allow onboard computer 100 to receive third party contents by configuring settings of accounts with third party devices 90 or settings of mobile communication devices 80, 82.

Processing unit 104 may be configured to receive signals and process the signals to determine a plurality of conditions of the operation of vehicle 10, for example, operations of sensor 36 and operations of indicator system 140 through controller 120. Processing unit 104 may also be configured to generate and transmit command signals, via I/O interface 102, in order to actuate the devices in communication.

In some embodiments, processing unit 104 may be configured to determine the presence of people within an area, such as occupants of vehicle 10. Processing unit 104 may be configured to determine the identity of the occupants through a variety of mechanisms. For example, processing unit 104 may be configured to determine the presence of specific people based on a digital signature from mobile communication devices 80, 82. For instance, processing unit 104 may be configured to relate the digital signature to stored data including the person's name and the person's relationship with vehicle 10. The digital signature of communication device 80 may include a determinative emitted radio frequency (RF), GPS, Bluetooth™, or WiFi unique identifier. Processing unit 104 may also be configured to determine the presence of people within vehicle 10 by GPS tracking software of mobile communication devices 80, 82. In some embodiments, vehicle 10 may be configured to detect mobile communication devices 80, 82 when mobile communication devices 80, 82 connect to local network 70 (e.g., Bluetooth™ or WiFi).

In some embodiments, processing unit 104 may also be configured to recognize occupants of vehicle 10 by receiving inputs with user interface 26. For example, user interface 26 may be configured to receive direct inputs of the identities of the occupants. User interface 26 may also be configured to receive biometric data (e.g., fingerprints) from occupants when manipulating user interface 26. Processing unit 104 may be further configured to recognize occupants by facial recognition software used in conjunction with sensor 36.

In some embodiments, processing unit 104 may be configured to access and collect sets of data related to the people within the area in a number of different manners. Processing unit 104 may be configured to store the sets of data in a database. In some embodiments, processing unit 104 may be configured to access sets of data stored on mobile communication devices 80, 82, such as apps, audio files, text messages, notes, messages, photos, and videos. Processing unit 104 may also be configured to access accounts associated with third party devices 90, by either accessing the data through mobile communication devices 80, 82 or directly accessing the data from third party devices 90. Processing unit 104 may be configured to receive data directly from occupants, for example, through access of user interface 26. For example, occupants may be able to directly input vehicle settings, such as a desired internal temperature. Processing unit 104 may also be configured to receive data from history of previous inputs of the occupant into user interface 26.

In some embodiments, processing unit 104 may be configured to extract data from the collected sets of data to determine the occupant's interests and store the extracted data in a database. For example, processing unit 104 may be configured to determine favorite restaurants or types of food through occupant search histories or Yelp™ reviews. Processing unit 104 may be configured to store data related to an occupant's previous destinations using vehicle 10. Processing unit 104 may further be configured to execute character recognition software to determine the contents of messages or posts of occupants on social media to recognize keywords related to interests.

Storage unit 106 and/or memory module 108 may be configured to store one or more computer programs that may be executed by onboard computer 100 to perform functions of system 12. For example, storage unit 106 and/or memory module 108 may be configured to store biometric data detection and processing software configured to determine the identity of people based on fingerprint(s), and store image recognition software configured to relate images to identities of people. Storage unit 106 and/or memory module 108 may be further configured to store data and/or look-up tables used by processing unit 104. For example, storage unit 106 and/or memory module 108 may be configured to include data related to individualized profiles of people related to vehicle 10. In some embodiments, storage unit 106 and/or memory module 108 may store the stored data and/or the database described in this disclosure.

Vehicle 10 can also include a controller 120 connected to the onboard computer 100 and capable of controlling one or more aspects of vehicle operation, such as performing autonomous parking or driving operations, using instructions from the on-board computer 100.

In some examples, the controller 120 is connected to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. Steering system 137 may include steering wheel 22 described above with reference to FIG. 1. The onboard computer 100 can control, via controller 120, one or more of these actuator systems 130 during vehicle operation; for example, to open or close one or more of the doors of the vehicle using the door actuator system 138, to control the vehicle during autonomous driving or parking operations, using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle or part of user interface 26), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). Onboard computer 100 can control, via controller 120, one or more of these indicator systems 140 to provide indications to a driver of the vehicle of one or more characteristics of the vehicle's surroundings. The characteristics may be determined by sensor 36.

FIG. 4 is a flowchart illustrating a method 400 for vehicle-based image-capturing, consistent with exemplary embodiments of the present disclosure. Method 400 may include a number of steps, some of which may be optional. For example, step 404 may be optional. The steps described below may also be rearranged in another order.

In Step 402, one or more components of system 12 described above may receive an input. The one or more components of system 12 may also transmit the received input to onboard computer 100 (e.g., processing unit 104). The input may be a user input from a user of a vehicle. The user may be a current occupant of the vehicle or may not be physically inside the vehicle. For example, user interface 26 may receive an input entered by one or more occupants of the vehicle. For another example, first mobile communication device 80, second mobile communication device 82, and/or third party device 90 may receive an input from a current occupant of the vehicle or from a user sitting in a living room, and transmit the input to processing unit 104. The input may also be generated by a human or by a non-human being, such as a computer, a machine, an algorithm, or a software. The input may be received while the vehicle is moving or parked.

The user input may include many forms and representations. For example, the user input can be a user entered or selected command on user interface 26. For another example, the user input can be a voice command or a brain wave command captured by user interface 26 or mobile communication devices 80, 82. Exemplary user inputs may include “capturing a left-side view now,” “capturing a few nice ocean views on the way to house ABC later today,” “taking a few photos of congregations along the way,” “taking random pictures,” and “taking a 360 degree view from the top.”

At step 404, one or more components of system 12 may determine a status of the vehicle. For example, processing unit 104 may receive the user input from user interface 26 and determine the status of the vehicle. The status may include various parameters of the vehicle, such as the vehicle engine ON/OFF state, a current velocity of the vehicle, a current position of the vehicle, and a current time with respect to the vehicle location. Processing unit 104 may communicate with and/or control various components of system 12, such as motor 131, transmission gearing 134, and detector and GPS 24 to perform step 404.

In some embodiments, one or more components of system 12, such as processing unit 104, may determine when to execute the following steps of method 400 based on the user input and the determined status. For example, if the received user input is “capturing a left-side view now” and the status is determined to be “vehicle cruising,” processing unit 104 may allow the following steps to be executed. For another example, if the received user input is “capturing a few nice ocean views on the drive to house ABC later today” and the status is determined to be “vehicle parked,” processing unit 104 may pause performing the following steps. At a later time when processing unit 104 determines that the vehicle is moving along a route to house ABC, for example, by analyzing information such as a GPS route entered by the user, a current velocity, and/or a current position of the vehicle, execution of the following steps of method 400 may be resumed.

At step 406, one or more components of system 12 may detect an image target based on the input and the determined status. For example, one or more sensors of sensor 36, e.g., second sensor 362, may detect the image target.

In some embodiments, second sensor 362 may include a camera, a LIDAR sensor, or a combination of both, and second sensor 362 may be configured to track one or more objects that are detected as the image target(s). For example, if the received user input is “taking some photos of birds, second sensor 362 may determine one or more targets that match with the user input based on an image recognition software. Second sensor 362 may also adjust parameters, such as viewing angle, focus, and field of view, in real time to keep tracking the one or more targets. For another example, if the received user input is “taking a left-side view now” or “taking a panorama view form the top,” second sensor 362 may determine that no object needs to be tracked and that a general view from the sensor is the image target.

At step 408, one or more components of system 12 may capture an image of the detected image target. For example, one or more sensors of sensor 36, e.g., first sensor 361, may capture the image of the detected image target. The image may be captured while the vehicle is still or in motion, with appropriate configurations of the sensors, such as adjustments of the shutter speed and the focus.

In some embodiments, first sensor 361 may include a camera, a high-speed camera, a panorama camera, an IR camera, a video recorder, and the like. First sensor 361 may capture one or more images and/or videos of the image target. Processing unit 104 may select from the one or more images and/or video frames to present on user interface 26. Processing unit 104 may also store the one or more images and/or video frames in storage unit 106, memory module 108, memories on mobile communication devices or third party devices, and the like. First sensor 361 may adjust various parameters while capturing the one or more images and/or videos, and the parameters may include viewing angle, shutter speed, exposure level, focal length, aperture, numerical aperture, light sensitivity, white balance, and the like. For example, if the image target is a flying eagle, a first sensor 361f disposed on top of the vehicle may capture one or more images and/or videos of the eagle. With respect to the image capture, first sensor 361f may adjust a focus, a viewing angle, and/or a shutter speed in real-time to keep the eagle within a capturing frame of the sensor and focused. First sensor 361f may adjust the focus, the viewing angle, and/or the shutter speed according to real-time measurements taken by second sensor 362a and/or 362b. Second sensor 362 may be one or more LIDAR sensors which can track the eagle's relative position, distance, and/or velocity. In some embodiments, the adjustment(s) may be controlled, coordinated, and/or executed by processing unit 104. First sensor 361 may also capture a video of the eagle to obtain a series of images frames.

In some embodiments, the processing unit may selectively set the first sensor and/or second sensor to an ON, OFF, or standby state, based on the user input, time, and/or location. For example, when processing unit 104 does not receive any user input, has finished executing a user input, or has determined a future execution of a user input, processing unit 104 may set the first and/or the second sensor to an OFF or standby state to preserve battery. For another example, the processing unit 104 may set the first sensor to ON for 10 minutes every day at dawn to capture images of the sun rise. For another example, processing unit 104 may set the first sensor to remain OFF and turn it on when a part of the vehicle is hit or damaged, so the first sensor can wake up to capture images on objects that hit or damaged the vehicle. For another example, processing unit 104 may set the first sensor to always ON when the vehicle is parked in an area with a high crime rate.

In some embodiments, one or components of system 12 may determine each occupant's identity, by executing a software such as an image recognition software, a voice recognition software, or a weight recognition software, based on the received data from sensor 36 and/or user interface 26. For example, sensor 36 may detect a digital signature or other identification information from mobile communication devices that occupants carry, and processing unit 104 may determine the occupants' identities based on the digital signatures. Processing unit 104 may access and collect sets of data related to each occupant in vehicle 10. Processing unit 104 may determine whether the determined occupants have stored profiles. Processing unit 104 may also access sets of data stored on mobile communication device 80, 82 and third party devices 90 to update the stored profile(s). If an occupant does not have a stored profile, processing unit 104 may generate a profile based on the accessed data. Each profile may include information such as age, gender, driving license status, driving habit, associated photo album, frequent destination, and enrolled store reward program. Each profile may also include information regarding one or more photos associated with the occupant, such as when and where the photos were taken, objects in the photos, people in the photos, themes of the photos, and photo content patterns. The one or more photos may be stored in a mobile communication device, a third party device, or in servers accessible through a network. For example, the processing unit 104 may obtain photos stored in the occupant's smart phone through wireless connections. Processing unit 104 may determine each of the occupant's preferences, for example, in audio, movies, food, photography, and travel destinations, and make recommendations. For example, processing unit 104 may determine, based on stored photo albums of user A, that user A is an animal lover. Thus, when user A inputs a navigation destination at a beginning of a trip and a determined route passes through a national park, processing unit 104 may recommend an “auto-capturing of animal photos” option to user A on user interface 26. After capturing, processing unit 104 may upload the captured images including camera information to the mobile communication devices, the third party devices, or a social network account associated with the occupant. The processor unit 104 may automatically determine and instruct the on-board cameras to take images based on the occupant or user's preferences. Also, the processor unit 104 may automatically determine and instruct the on-board cameras to take images based on the user's preferences, even someone else is driving the vehicle and the user is not on the vehicle. For example, the processor unit 104 may determine that a user is an animal lover, and the processor unit 104 may instruct the cameras on the vehicle to take images of animals whenever the on-board sensors detect an animal.

In some embodiments, one or more components of system 12 may capture an image based on global positioning system (GPS) information of the vehicle. For example, if detector and GPS unit 24 detects a current position of the vehicle close to a point of interest (e.g., based on public interest, personal interest, public information, personal search history, personal album information, and the like), processing unit 104 may control the first sensor to capture images of objects at the points of interest. For another example, if detector and GPS unit 24 determines that the vehicle is close to the venue of this year's Met Gala, second sensor 362 detects a large crowd is gathering by a red carpet, and processing unit 104 determines that a current driver of the vehicle works in the fashion industry, processing unit 104 may control first sensor 361 to capture images of the event and/or people walking down the red carpet.

In some embodiments, multiple vehicles 10 may communicate among one another or with third party device 90 or mobile communication devices 80, 82 through network 70 about the image target. For example, if a vehicle detects a bear family crossing a road, it may transmit such information to nearby vehicles based on the GPS information to alert the drivers. For another example, if a vehicle detects a dog, it may search a lost dog registry or other public information to determine if this is a lost dog, based on image matching, the probable location, and the color.

In some embodiments, the above-described systems and methods may detect a damage to the vehicle, such as a smash of a vehicle window or a scratch on a vehicle body, through one or more onboard sensors, and in response, processing unit 104 may turn on the first sensor to capture images and/or videos of the surroundings. For example, a sensor on vehicle 10 detects a hit on a front bumper, processing unit 104 may turn on a front camera to capture a video.

In some embodiments, the above-described systems and methods may detect an intruder of the vehicle and capture an image of the intruder. For example, vehicle 10 may detect, through one or more onboard sensors, e.g., sensor 363, that a person is tampering with a vehicle lock or a person entering the vehicle is recognized as a fugitive. Processing unit 104 may alert the owner of the vehicle, transmit an alarm to the police, and/or turn on one or more sensors of sensor 36 to start filming.

In some embodiments, the above-described systems and methods may capture an image based on a pre-determined mode and/or input from a network (e.g., an input from sensors in the network or an input based on information from the network). For example, vehicle 10 may be parked by a house, set to an “on-guard” mode, and connected with security sensors of the house. With the “on-guard” mode, processing unit 104 may set first sensor 361 to OFF when the house sensors indicates everything normal, and may set first sensor 361 to ON when the house sensor indicates otherwise. For another example, the vehicle 10 may be set on “on-guard” mode whenever the vehicle 10 is parked at a location (e.g., obtained through GPS) and/or within certain time frame. For example, the vehicle 10 can be set on “on-guard” mode when it is parked in front of the house during the night, with first sensor 361 on, to serve as surveillance cameras. The vehicle 10 may be configured to beep or send out alarms when it detects intruders of the vehicle 10 or the house. Processing unit 104 may also communicate with nearby vehicles and sensors to focus capturing images toward a location suggested by the house sensors. For another example, vehicle 10 may be moving around a neighborhood and set to a “standby” mode. When it receives a public message such as an AMBER alert associated the neighborhood, vehicle 10 may set the first sensor to ON.

Most of the examples are described in connection with taking images or photos. A person having ordinary skill in the art should appreciate that the sensors can also record videos, voices, etc.

In some embodiments, the above-described systems and methods can be applied to competition vehicles, such as race cars and motorcycles. For example, the systems and methods can be implemented to assist with racing by monitoring vehicle maneuvers. Output generated by the systems can be transmitted to third party device 90, e.g., a computer, for further analysis by a race crew to improve the driver's performance or to identify causes for accidents.

In some embodiments, the above-described systems and methods can be applied to vehicles in a platoon. Vehicles traveling in a platoon may travel in a formation with small separations, and accelerate and brake together. Autonomous vehicles may join or leave the platoon formation automatically. Vehicles in a platoon may communicate with each other and request one or more sensor from other vehicle in the platoon to perform one or more steps of method 400 described above. For example, a front camera of a first vehicle just joining a platoon may be blocked by a second vehicle in front, the first vehicle may request a third vehicle, which is the leading vehicle of the platoon, to capture images with its front camera and transmit the images to the first vehicle. The first vehicle may also request all vehicles in the platoon to simultaneously capture images from the left side and stitch all captured images together to obtain a panorama picture.

Another aspect of the disclosure is directed to a non-transitory computer-readable medium storing instructions which, when executed, cause one or more processors to perform the method, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for vehicle-based image-capturing. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A system for vehicle-based image-capturing, the system comprising:
an interface configured to receive an input; and
a first sensor, of a vehicle, configured to capture an image based on the input.

2. The system of claim 1, wherein the first sensor is integrated with the vehicle and configured to capture an image of one or more objects outside the vehicle.

3. The system of claim 1, further comprising:
a processing unit configured to determine a status of the vehicle based on the input; and
a second sensor configured to detect an image target based on the input and the determined status, wherein the first sensor is configured to capture an image of the detected image target.

4. The system of claim 3, wherein:
the first sensor is a camera; and
the second sensor is a light detection and ranging (LIDAR) sensor.

5. The system of claim 3, wherein the processing unit is further configured to adjust one or more configurations of the first sensor based on the detected image target.

6. The system of claim 5, wherein:
the first sensor is configured to capture a video based on the input; and
the processing unit is further configured to:
select one or more frames of the captured video as selected images, and
present the selected images to the user.

7. The system of claim 5, wherein the processing unit is further configured to adjust the first sensor to focus on the detected image target.

8. The system of claim 5, wherein the processing unit is further configured to set the first sensor to an ON, OFF, or standby state.

9. The system of claim 5, further comprising a global positioning system (GPS) unit configured to detect a position of the vehicle, wherein the first sensor is configured to capture the image based on the input and the detected position.

10. A vehicle comprising a system for vehicle-based image-capturing, the system comprising:
an interface configured to receive an input; and
a first sensor configured to capture an image based on the input.

11. The vehicle of claim 10, wherein the first sensor is integrated with the vehicle and configured to capture an image of one or more objects outside the vehicle.

12. The vehicle of claim 10, wherein:
the system further comprises:
a processing unit configured to determine a status of the vehicle based on the input, and
a second sensor configured to detect an image target based on the input and the determined status; and
the first sensor is configured to capture an image of the detected image target.

13. The vehicle of claim 12, wherein:
the first sensor is a camera; and
the second sensor is a light detection and ranging (LIDAR) sensor.

14. The vehicle of claim 12, wherein the processing unit is further configured to adjust one or more configurations of the first sensor based on the detected image target.

15. The vehicle of claim 14, wherein:
the first sensor is configured to capture a video based on the input; and
the processing unit is further configured to:
select one or more frames of the captured video as selected images, and
present the selected images to the user.

16. The vehicle of claim 14, wherein the processing unit is further configured to adjust the first sensor to focus on the detected image target.

17. The vehicle of claim 14, wherein the processing unit is further configured to set the first sensor to an ON, OFF, or standby state.

18. The vehicle of claim 14, wherein:
the system further comprises a GPS unit configured to detect a position of the vehicle; and
the first sensor is configured to capture the image based on the input and the detected position.

19. A method for vehicle-based image-capturing, the method comprising:
receiving, by an interface, an input; and
capturing, by a first sensor of a vehicle, an image based on the input.

20. The method of claim 19, wherein capturing the image based on the input comprises:
determining, by a processing unit, a status of the vehicle based on the input;
detecting, by a second sensor of the vehicle, an image target based on the input and the determined status; and
capturing, by the first sensor of the vehicle, an image of the detected image target.
